(19) United States
(12) Patent Application Publication
(10) Pub. No.: US 2013/0134778 A1
(43) Pub. Date: May 30, 2013

(54) BATTERY MANAGEMENT SYSTEM

(71) Applicant: HONDA MOTOR CO., LTD, Tokyo (JP)

(72) Inventor: Ryusuke Tamanaha, Wako-shi (JP)

(73) Assignee: HONDA MOTOR CO., LTD, Tokyo (JP)

(21) Appl. No.: 13/680,440

(22) Filed: Nov. 19, 2012

(30) Foreign Application Priority Data
Nov. 25, 2011 (JP) 2011-257569

(51) Int. Cl. B60L 3/12

(52) U.S. Cl. CPC B60L 3/12
USPC 307/10.1

(57) ABSTRACT

A vehicle controls power consumption of a battery on the basis of a target battery remaining amount set by a user and detects or stores a deterioration-related parameter relating to deterioration of the battery. A server calculates a deterioration parameter coefficient that represents the degree of the effect of the deterioration-related parameter on the deterioration of the battery. The vehicle controls the power consumption of the battery in accordance with the deterioration parameter coefficient and the deterioration-related parameter. The degree of actual battery deterioration is calculated on the basis of the actual battery remaining amount at a point when the vehicle reaches a destination. A table for use in calculating the deterioration parameter coefficient is modified in accordance with the degree of actual battery deterioration.

### CROSS REFERENCES TO RELATED APPLICATIONS

The present application claims priority under 35 U.S.C. §119 to Japanese Patent Application No. 2011-257569, filed Nov. 25, 2011, entitled “Battery Management System.” The contents of this application are incorporated herein by reference in their entirety.

### TECHNICAL FIELD

The present disclosure relates to a battery management system for appropriately managing the charge remaining amount of a battery in a vehicle that includes a motor driven by power supplied from the battery as a power source.

### BACKGROUND

A control device for use in a hybrid vehicle that includes an engine and a motor as power sources is illustrated in Japanese Unexamined Patent Application Publication No. 2008-100645. This control device controls the engine and the motor such that the charge remaining amount of the battery (hereinafter referred to as “battery remaining amount”) is substantially the same as a target battery remaining amount when the vehicle reaches a destination set by a driver. The control device includes a unit that receives an intention whether the driver intends to charge the battery at the destination as charge intention information, and the target battery remaining amount is modified in accordance with the charge intention information. This enables appropriately controlling the ratio between driving by the motor and driving by the engine and appropriately performing drive energy control in accordance with charging or not charging of the battery at the destination.

The performance of the battery for storing electricity varies with the degree of deterioration of the battery. Thus, the degree of deterioration of the battery may preferably be considered in controlling power consumption of the battery such that the battery remaining amount is substantially the same as the target battery remaining amount. The above-described known device does not perform driving energy control considering this respect (energy management). Thus, the control accuracy may be lower in controlling the battery remaining amount such that it is substantially the same as the target battery remaining amount.

The speed of deterioration of the battery varies depending on the state of use, such as the time of use and environmental temperature. Thus, it is necessary to consider the degree of the effect of the state of use on the deterioration of the battery in order to appropriately perform the drive energy control in accordance with the degree of deterioration of the battery.

### SUMMARY

The present application describes a battery management system capable of appropriately performing drive energy control in a vehicle that includes a motor driven by power supplied from a battery as a power source and controlling the battery remaining amount at a destination such that it is substantially the same as a target battery remaining amount with higher precision.

A battery management system according to an aspect of the present application includes a vehicle and a server. The vehicle includes a battery and a motor driven by power supplied from the battery as a power source. The server is wirelessly connectable to the vehicle to communicate with each other. The vehicle further includes a target battery remaining amount setting unit for setting by a user a destination and a target battery remaining amount when the vehicle reaches the destination, a power consumption control unit that controls power consumption of the battery on the basis of the set target battery remaining amount, and a parameter detecting or storing unit that detects or stores a deterioration-related parameter relating to deterioration of the battery. The server includes a correlation storing unit that stores correlation between the deterioration-related parameter and a deterioration parameter coefficient representing a degree of an effect of the deterioration-related parameter on the deterioration of the battery. The vehicle or the server includes an estimated battery deterioration degree calculating unit that calculates a degree of an estimated battery deterioration in accordance with the deterioration-related parameter and the correlation and an actual battery deterioration degree calculating unit that calculates a degree of an actual battery deterioration on the basis of an actual battery remaining amount at a point when the vehicle reaches the destination. The vehicle and the server exchange necessary information with each other. The power consumption control unit controls the power consumption of the battery by referring to the degree of the estimated battery deterioration. The server modifies the correlation stored in the correlation storing unit in accordance with the degree of the actual battery deterioration.

With the above-described battery management system, the user sets the destination and the target battery remaining amount when the vehicle reaches the destination, and the power consumption of the battery is controlled on the basis of the set target battery remaining amount. The deterioration-related parameter relating to the deterioration of the battery is detected or stored, and the deterioration parameter coefficient representing the degree of the effect of the deterioration-related parameter on the battery deterioration is calculated. Specifically, the deterioration parameter coefficient is calculated by referring to the correlation between the deterioration parameter coefficient and the deterioration-related parameter stored in the correlation storing unit in the server. In addition, the degree of the estimated battery deterioration is calculated in accordance with the calculated deterioration parameter coefficient and the deterioration-related parameter, and the power consumption of the battery is controlled by referring to the degree of estimated battery deterioration. The degree of the actual battery deterioration is calculated on the basis of the actual battery remaining amount at the point when the vehicle reaches the destination, and the correlation stored in the correlation storing unit in the server is modified in accordance with the degree of actual battery deterioration. That is, because the correlation stored in the correlation storing unit is modified in accordance with the status of actual use of the battery (probe information), the accuracy of calculating the degree of estimated battery deterioration can be improved, and the power consumption of the battery can be appropriately controlled. As a result, the actual battery remaining amount when the destination is reached can be closer to the target battery remaining amount with high precision.

In the above-described battery management system, the deterioration-related parameter may include at least one of a serial number of the battery, an outside air temperature, a weight of the vehicle, and a total travel time of the vehicle.

With the above-described battery management system, the serial number of the battery, the outside air temperature, the weight of the vehicle, and/or the total travel time of the vehicle may be used as the deterioration-related parameter. These parameters have been confirmed to be highly correlated with the battery deterioration. Thus, the use of at least one of these parameters as the deterioration-related parameter can improve the accuracy of calculating the degree of estimated battery deterioration and enables the power consumption of the battery to be appropriately controlled.

In the above-described battery management system, the vehicle or the server may further include a determining unit that determines whether the target battery remaining amount set by using the target battery remaining amount setting unit is proper and a modified target battery remaining amount calculating unit that calculates a modified target battery remaining amount by modifying the set target battery remaining amount when the set target battery remaining amount is determined to be improper. The power consumption control unit may control the power consumption of the battery on the basis of the modified target battery remaining amount.

With the above-described battery management system, it is determined whether the target battery remaining amount set by the user is proper. When the set target battery remaining amount is determined to be improper, the modified target battery remaining amount is calculated by modifying the set target battery remaining amount. The power consumption of the battery is controlled on the basis of the modified target battery remaining amount. The target battery remaining amount set by the user may be an improper value resulting from a typing error, a misunderstanding, or other reasons. In such a case, by modifying the set target battery remaining amount, appropriate control of the power consumption is enabled during the travel of the vehicle.

### BRIEF DESCRIPTION OF THE DRAWINGS

The advantages of the disclosure will become apparent in the following description taken in conjunction with the following drawings.

FIG. 1 illustrates the configuration of a battery management system according to an embodiment.

FIG. 2 is a block diagram that illustrates the configuration of major portions of a vehicle and a server included in the battery management system.

FIG. 3 is a flowchart of a control process performed by a vehicle controller illustrated in FIG. 2.

FIG. 4 is a flowchart of a control process performed by a battery management controller illustrated in FIG. 2.

FIG. 5 illustrates tables referred to in the process illustrated in FIG. 4.

FIG. 6 illustrates an example of tables modified on the basis of probe information.

FIG. 7 is a flowchart of a control process (second embodiment) performed by the vehicle controller illustrated in FIG. 2.

FIG. 8 is an illustration for describing the process illustrated in FIG. 7.

### DETAILED DESCRIPTION

Embodiments are described below with reference to the drawings.

### First Embodiment

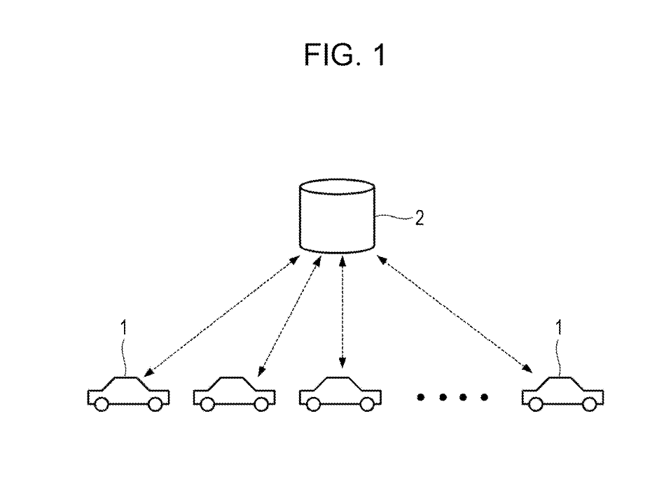

FIG. 1 illustrates the configuration of a battery management system according to an embodiment. This battery management system includes a plurality of vehicles 1 and a server 2 connected to the vehicles 1. The server 2 can carry out wireless communication with the vehicles 1. The vehicles 1 have their respective batteries of the same specifications.

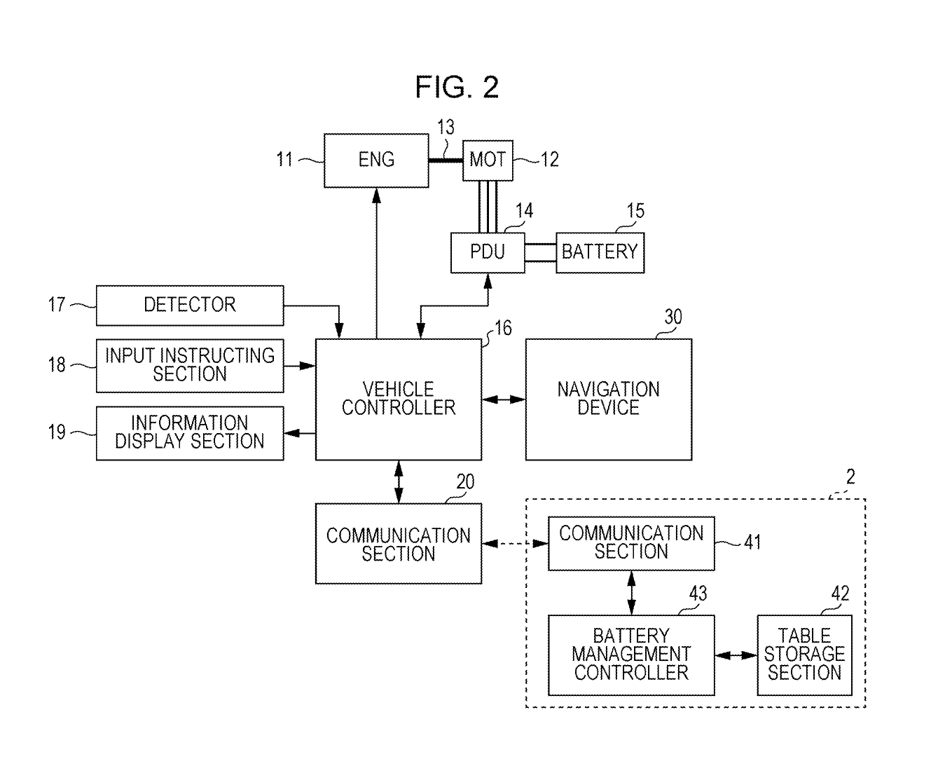

FIG. 2 is a block diagram that illustrates major portions of each of the vehicles 1 and the server 2. That is, the vehicle 1 includes an internal combustion engine (hereinafter referred to as “engine”) 11 as a first power source, a motor 12 arranged so as to drive a drive shaft (crankshaft) 13 of the engine 11, a power drive unit (hereinafter referred to as “PDU”) 14, a battery 15, a vehicle controller 16, a detector 17, an input instructing section 18, an information display section 19, a communication section 20, and a navigation device 30. The server 2 includes a communication section 41, a table storage section 42, and a battery management controller 43.

In the vehicle 1, a vehicle driving system is configured so as to enable the drive shaft 13 to drive the driving wheels through a power transmission mechanism (not illustrated). The motor 12 has a regenerative function of converting a kinetic energy produced by rotation of the drive shaft 13 into an electrical energy. The motor 12 is connected to the PDU 14. The PDU 14 is connected to the battery 15. When the motor 12 is driven by a positive driving torque, that is, when the motor 12 is driven by power output from the battery 15, the power output from the battery 15 is supplied to the motor 12 through the PDU 14. When the motor 12 is caused to perform a regenerative operation, the power generated by the motor 12 is supplied to the battery 15 through the PDU 14 and the battery 15 is charged. The PDU 14 includes a battery remaining amount detector that detects a charge remaining amount of the battery 15 (battery remaining amount) Bs, and the detected battery remaining amount Bs is supplied to the vehicle controller 16. In the present embodiment, the battery remaining amount Bs is defined as the ratio to a full charge amount CBF. Thus, the value of Bs ranges between 0 and 1 inclusive.

The detector 17 detects parameters indicating the driven state of the engine 11 (e.g., engine rotation speed NE, PBA), outside air temperature TA, atmospheric pressure PA, and other parameters and supplies detected signals corresponding to them to the vehicle controller 16. The input instructing section 18 can include a keyboard or a touch panel for use by a user (driver or passenger) of the vehicle 1 in setting a destination and a target battery remaining amount Bg when the destination is reached by the vehicle land supplies input information to the vehicle controller 16. The information display section 19 can include a liquid crystal display device, for example, and displays information, such as information input through the input instructing section 18 and map information and vehicle position information in the navigation device 30. The communication section 20 exchanges necessary information with the server 2.

The vehicle controller 16 is an electronic control unit including a central processing unit (CPU), a memory, an input circuit, and an output circuit and includes, for example, an engine control unit, a motor control unit, an air-conditioner control unit, a transmission control unit, and other units. The vehicle controller 16 performs the drive energy control such that the battery remaining amount Bs is close to (nearly identical with) the target battery remaining amount Bg at the destination. The vehicle controller 16 performs or provides various functions such as those described in the present application by means of the CPU which executes a program. In the present application, the term program generally refers to a set of coded instructions that enable a computer to perform a specified function. Programs may be generally stored on a storage device such as memory. Further, programs may be implemented internally or externally to a system, while remaining accessible by that system.

The navigation device 30 has height information for main geographical points, in addition to the normal navigation function. When a route to a destination is determined, the navigation device 30 supplies correlation between a travel distance and a height change (hereinafter referred to as “travel route height information IHPATH”) to the vehicle controller 16. The navigation device 30 may include an own processor to perform various functions such as those described in the present application by executing a program.

The communication section 41 in the server 2 exchanges necessary information with the vehicle 1. The table storage section 42 may be implemented by a memory device or a storage device. The table storage section 42 stores β1 table to β4 table representing correlation between deterioration parameter coefficients βn (n=1 to 4) indicating the degrees of the effect on the deterioration of the battery 15 and vehicle driving state parameters relating to the deterioration of the battery 15 (hereinafter referred to as “deterioration-related parameters”). The battery management controller 43 performs a process for managing the state of use of the battery of the vehicle 1. In the present embodiment, a vehicle weight WV of the vehicle 1, a mean outside air temperature TAAVE, a total travel time TDRV of the battery 15 from the start of its use, and a serial number NPLOT of the battery 15 are used as the deterioration-related parameters. An example of the mean outside air temperature TAAVE can be a mean value of the outside air temperature TA for the past one hour from the present time. The serial number NPLOT is stored in advance in the memory of the vehicle controller 16. For example, the server 2 may be implemented by a computer that performs or provides various functions such as those described in the present application by means of a processor which executes a program. The server 2 may be implemented as a cloud server in a cloud computing environment. The memory device implementing the table storage section 42 may also implement the weight coefficient storing unit.

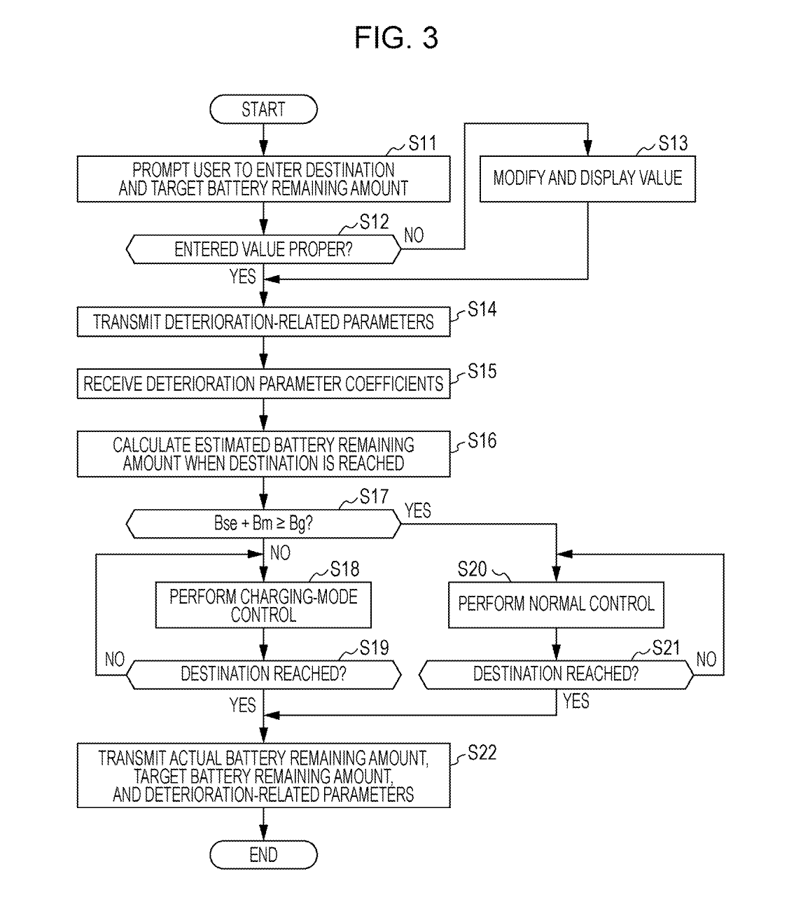

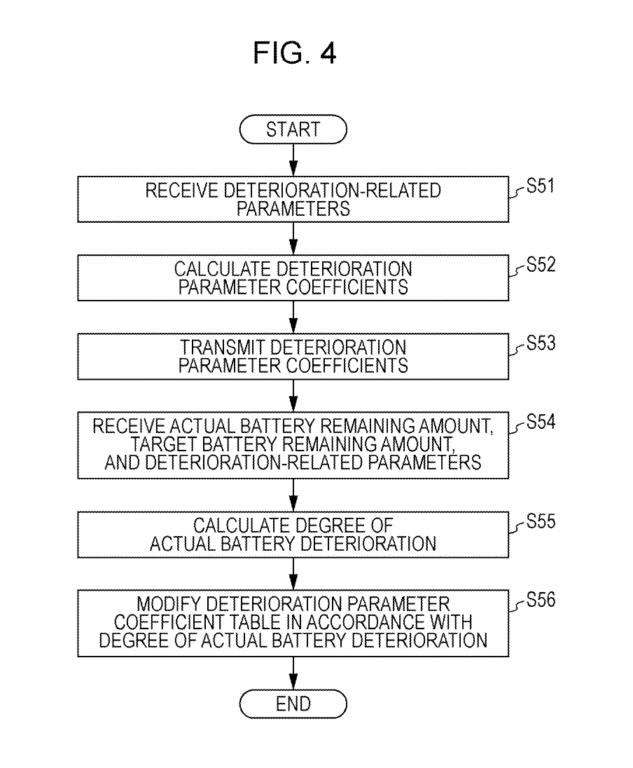

FIG. 3 is a flowchart of drive energy control performed by the vehicle controller 16 of the vehicle 1. FIG. 4 is a flowchart of battery management control performed by the battery management controller 43 of the server 2. A control operation is described below with reference to both drawings.

In step S11, an instruction that prompts a user to enter a destination and a target battery remaining amount Bg is displayed. When the destination and the target battery remaining amount Bg are entered, it is determined whether the entered value is proper (step S12). When the entry is estimated to be an apparent error, for example, when the set value is larger than “1.0” or when the set target battery remaining amount Bg is significantly larger than the present battery remaining amount Bs although most of the route to the destination is an uphill road, it is determined that the entered value is determined to be improper (NO in step S12). In step S13, the target battery remaining amount Bg is modified, and the modified target battery remaining amount Bg is displayed on the information display section 19 to ask for approval of the user. When the approval is obtained, the process proceeds to step S14. When the approval is not obtained, which is not illustrated, the user is prompted to reenter a value; when the reentered value is proper, the process proceeds from step S12 to step S14.

In step S14, the above-described deterioration-related parameters WV, TAAVE, TDRV, and NPLOT are transmitted to the server 2.

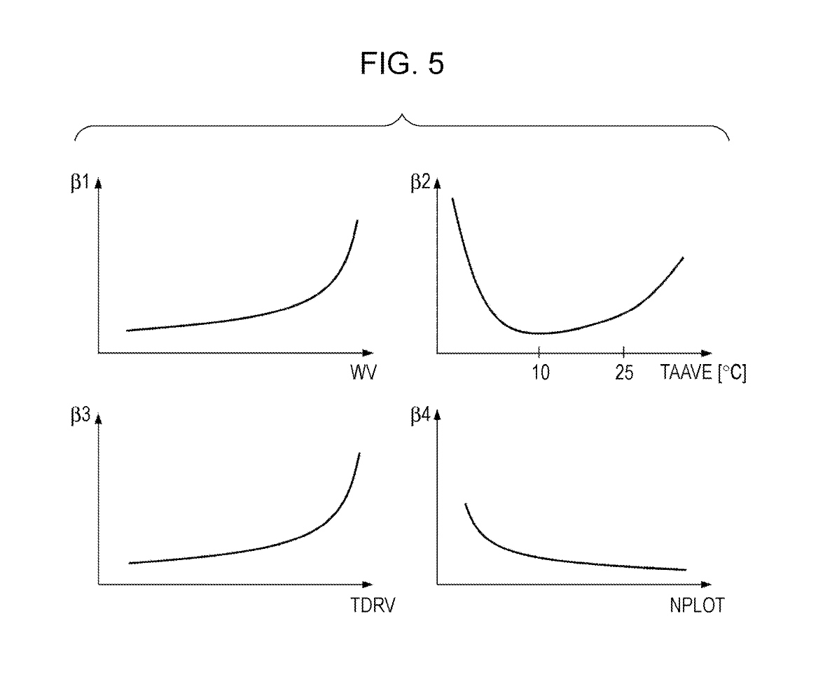

In response to this transmission, in step S51 in FIG. 4, the transmitted deterioration-related parameters WV, TAAVE, TDRV, and NPLOT are received, and the deterioration parameter coefficients β1 to β4 corresponding to the received deterioration-related parameters are calculated (step S52). Specifically, the first deterioration parameter coefficient β1 corresponding to the vehicle weight WV is retrieved from the β1 table illustrated in FIG. 5; the second deterioration parameter coefficient β2 corresponding to the mean outside air temperature TAAVE is retrieved from the β2 table illustrated in FIG. 5; the third deterioration parameter coefficient β3 corresponding to the total travel time TDRV is retrieved from the β3 table illustrated in FIG. 5; and the fourth deterioration parameter coefficient β4 corresponding to the serial number NPLOT is retrieved from the β4 table illustrated in FIG. 5.

The β1 table is set such that the first deterioration parameter coefficient β1 increases with an increase in the vehicle weight WV. The β2 table is set such that the second deterioration parameter coefficient β2 is the smallest when the mean outside air temperature TAAVE is at about 10° C. The β3 table is set such that the third deterioration parameter coefficient β3 increases with an increase in the total travel time TDRV. The β4 table is set such that the fourth deterioration parameter coefficient β4 increases as the date of manufacture indicated by the serial number NPLOT gets older. Each of the deterioration parameter coefficients β1 to β4 is set at a value in the range of from 0 to 1.

In step S53, the calculated deterioration parameter coefficients β1 to β4 are transmitted to the vehicle 1 that has transmitted the deterioration-related parameters.

Referring back to FIG. 3, in step S15, the transmitted deterioration parameter coefficients β1 to β4 are received, and an estimated battery remaining amount Bse when the destination is reached is calculated using the deterioration parameter coefficients β1 to β4 (step S16). A specific procedure of calculating the estimated battery remaining amount Bse is described below.

1) A non-deterioration degree coefficient α is calculated by applying the deterioration parameter coefficients β1 to β4 to the following expression (1). In the expression (1), Pn (n=1 to N, N=4) denotes a weight coefficient that is preset at a value in the range of from 0 to 1, and the non-deterioration degree coefficient α corresponds to a weighted mean value of the non-deterioration degree coefficients (1−βn) (n=1 to N, N=4) corresponding to the deterioration parameter coefficients.

$$α = {\sum }_{n = 1}^{N} Pn \times ( 1 - β n ) \text{/} N \qquad ( 1 )$$

2) An estimated charge consumption amount Dr required to travel to the destination and an estimated charge storage amount Cr being the amount of charge that can be stored during the travel to the destination are calculated in accordance with the travel route height information IHPATH and a travel distance DPATH from the present location of the vehicle 1 to the destination supplied from the navigation device 30. For example, when a downhill road exists in the travel route, the estimated charge storage amount Cr is larger than “0.” The estimated charge consumption amount Dr and estimated charge storage amount Cr are calculated on the basis of a reference state where the battery does not deteriorate, and they have a value indicating the ratio to the full charge amount CBF (between 0 and 1 inclusive), as in the case of the battery remaining amount Bs.

3) The estimated battery remaining amount Bse is calculated by applying the non-deterioration degree coefficient α, estimated charge consumption amount Dr, and estimated charge storage amount Cr to the following expression (2)

Bse=Bs−Dr/α+Cr×α (2)

In step S17, it is determined whether the value in which a margin Bm is added to the estimated battery remaining amount Bse is at or above the target battery remaining amount Bg. When the answer is positive (YES), normal drive energy control is performed until the destination is reached (steps S20 and S21). When the answer in step S17 is negative (NO) and thus the battery remaining amount Bs when the destination is reached may be smaller than the target battery remaining amount Bg, charging-mode control is performed until the destination is reached (steps S18 and S19). In the charging-mode control, electricity consumption is suppressed, for example, the operation of the air-conditioning device can be suppressed, for example.

When the destination is reached, the process proceeds to step S22, where the actual battery remaining amount Bs at that time, target battery remaining amount Bg, and deterioration-related parameters WV, TAAVE, TDRV, and NPLOT at that time are transmitted to the server 2.

In response to the transmission by the vehicle 1, the server 2 receives the transmitted actual battery remaining amount Bs, target battery remaining amount Bg, and deterioration-related parameters WV, TAAVE, TDRV, and NPLOT (step S54 in FIG. 4). Then, the degree DDA of actual battery deterioration is calculated by applying the actual battery remaining amount Bs and target battery remaining amount Bg to the following expression (3) (step S55). Expression (3) is defined such that the degree of deterioration is set at 0 when the actual battery remaining amount Bs when the destination is reached is equal to the target battery remaining amount Bg.

DDA=1−Bs/Bg (3)

In step S56, the deterioration parameter coefficient tables, that is, β1 table to β4 table are modified (caused to learn) in accordance with the degree DDA of actual battery deterioration. A specific procedure of the modification is described below.

1) A deterioration coefficient value βAn corresponding to the deterioration parameter coefficient βn is calculated by applying the degree DDA of actual battery deterioration and the above-described weight coefficient Pn to the following expression (4). In expression (4), ΣPn denotes the sum of the weight coefficients Pn (n=1 to N, N=4).

βAn=DDA×N×Pn/ΣPn (4)

2) By applying the deterioration coefficient value βAn to the following expression (5), a deterioration parameter coefficient value βn(XLn) is calculated. The expression (5) modifies the present deterioration parameter coefficient value βnZ(XLn) corresponding to the value XLn of the deterioration-related parameter (n=1 to 4, that is, value at this time of WV, TAAVE, TDRV, and NPLOT). In expression (5), CLRN denotes a learning coefficient set at a value that is in the range of from 0 to 1 and that is near 0 (e.g., 0.05).

βn(XLn)=CLRN×βAn+(1−CLRN)×βnZ(XLn) (5)

For example, in the case where the present value β2Z (15° C.) of the deterioration parameter coefficient β2 corresponding to 15° C. of the mean outside air temperature TAAVE is “0.2,” when the deterioration coefficient value βA2 calculated from expression (4) is “0.3,” the following calculation is made and the coefficient value β2 (15° C.) corresponding to the mean outside air temperature 15° C. in the β2 table is modified to “0.205.”

0.05×0.3+0.95×0.2=0.205

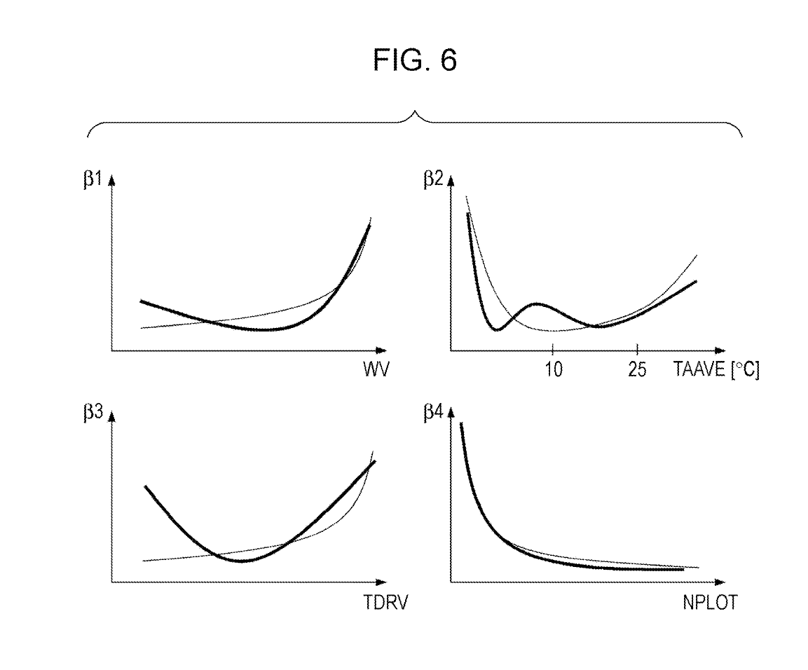

In this way, the Pn tables stored in the server 2 are modified using probe information that supports the state of actual use of the battery of the vehicle 1. Thus, when modification (learning) of each of the tables illustrated in FIG. 5 advances to some extent, it can change to the graph indicated by the thick line in the corresponding table illustrated in FIG. 6, for example, and the set characteristics of the table are close to those supporting the actual battery deterioration characteristics. By this modification or adjustment, the accuracy of calculating the estimated battery remaining amount Bse can be improved, and power consumption of the battery can be appropriately controlled. As a result, the accuracy of control may be enhanced in causing the actual battery remaining amount Bs when the destination is reached to be close to (nearly identical with) the target battery remaining amount Bg.

In the present embodiment, the input instructing section 18 in the vehicle 1 corresponds to the target battery remaining amount setting unit, the detector 17 corresponds to part of the parameter detecting or storing unit, and the vehicle controller 16 corresponds to the power consumption control unit, part of the parameter detecting or storing unit, the estimated battery deterioration degree calculating unit, the determining unit, and the modified target battery remaining amount calculating unit. The table storage section 42 in the server 2 corresponds to the correlation storing unit. The battery management controller 43 corresponds to the actual battery deterioration degree calculating unit. Specifically, steps S17 to S21 in FIG. 3 correspond to the power consumption control unit, step S16 corresponds to the estimated battery deterioration degree calculating unit, the β1 table to β4 table correspond to the correlation storing unit, and step S55 in FIG. 4 corresponds to the actual battery deterioration degree calculating unit. In the present embodiment, because the non-deterioration degree coefficient α is calculated in accordance with the deterioration parameter coefficient βn, (1−α) corresponds to the degree of estimated battery deterioration. These respective correspondences between the units and the specific elements of this embodiment are presented as mere examples, and thus, should not be interpreted to limit the scope of the accompanying claims to these examples.

### Second Embodiment

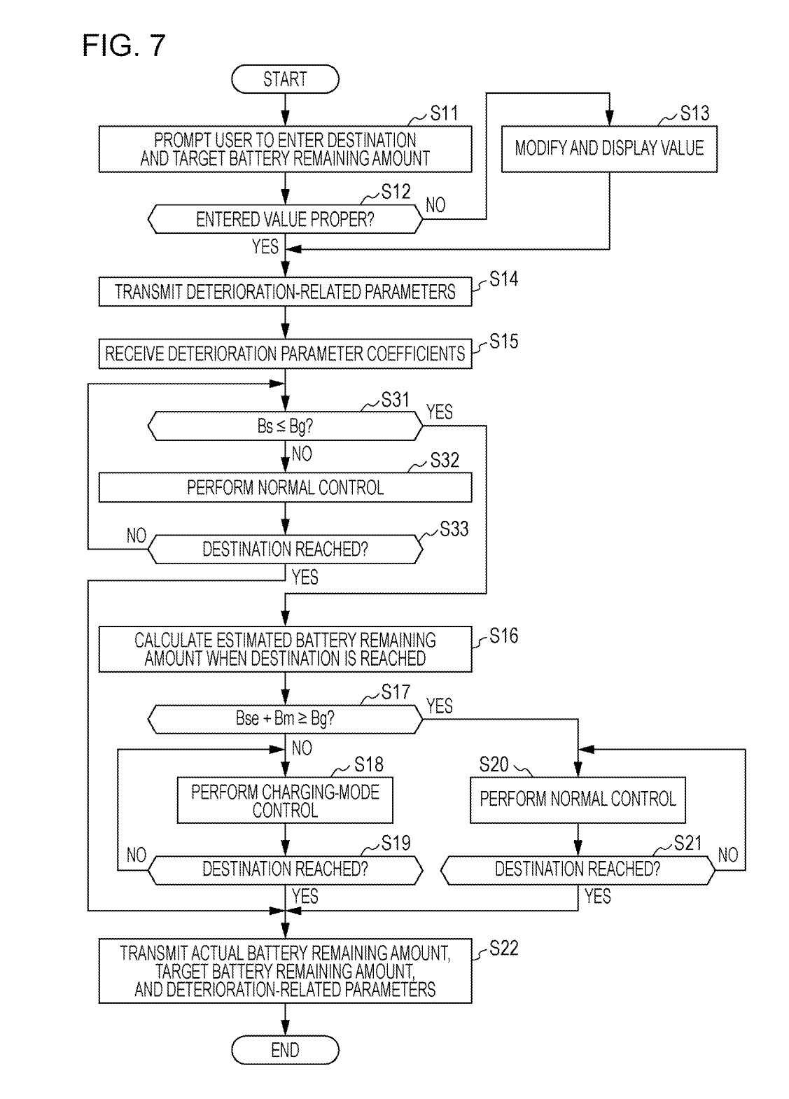

In this embodiment, the timing of calculating the estimated battery remaining amount Bse in the vehicle 1 is changed. In the present embodiment, in place of the process illustrated in FIG. 3, the process illustrated in FIG. 7 is performed by the vehicle controller 16. FIG. 7 illustrates the process in which steps S31 to S33 are added between steps S15 and S16 in the flowchart illustrated in FIG. 3. The present embodiment is the same as the first embodiment, except for the points described below.

In step S31 of FIG. 7, it is determined whether the battery remaining amount Bs is at or below the target battery remaining amount Bg. When the answer is negative (NO), normal drive energy control is performed (step S32). In step S33, it is determined whether the destination is reached. When the answer is negative (NO), the process returns to step S31.

When the answer in step S31 is positive (YES), that is, Bs≦Bg, the process proceeds to step S16. On the other hand, when the vehicle 1 reaches the destination, that is, the answer in step S33 is positive (YES), the process proceeds directly to step S22 by skipping steps S16-S21.

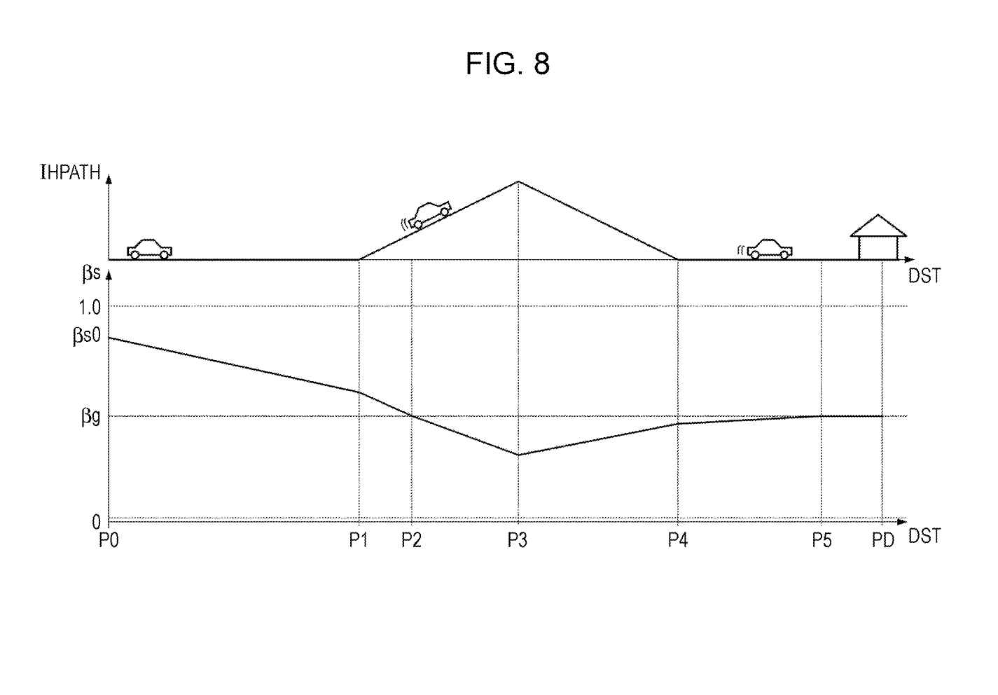

FIG. 8 is an illustration for describing the process illustrated in FIG. 7. The horizontal axis represents the travel distance DST. At the starting point P0, the battery remaining amount Bs is Bs0, normal drive energy control is initially performed (S31 and S32 in FIG. 7), and the battery remaining amount Bs gradually decreases. An uphill route begins from the point P1, the rate of decrease in the battery remaining amount Bs increases. At the point P2, the battery remaining amount Bs is substantially equal to the target battery remaining amount Bg. At this point, the process proceeds from step S31 to step S16 in FIG. 7, and the estimated battery remaining amount Bse is calculated. In the example illustrated in FIG. 8, because the battery can be charged in the downhill between the points P3 and P4 and in the section to the point P5, the answer in step S17 is positive (YES), and the normal control continues. Because the uphill route continues to the point P3, the battery remaining amount Bs decreases. When the battery is charged in the section from the point P3 to point P5, the battery remaining amount Bs increases. At the point P5, the battery remaining amount Bs is substantially equal to the target battery remaining amount Bg, and the state continues until the destination PD is reached.

As described above, in the present embodiment, at a point when the battery remaining amount Bs decreases to the target battery remaining amount Bg, the estimated battery remaining amount Bse is calculated, and charging-mode control is performed if needed. Accordingly, it is possible that the estimated battery remaining amount Bse is calculated at a point where the vehicle 1 is nearer to the destination, and thus, the calculation accuracy can be improved.

The present application is not limited to the above-described embodiments. Various modifications can be made. For example, the calculation of the non-deterioration degree coefficient α according to the deterioration parameter coefficient βn (calculation of the degree of estimated battery deterioration), determination whether the set target battery remaining amount Bg is proper, and calculation of the modified target battery remaining amount, which are performed in the vehicle controller 16 of the vehicle 1 in the above-described embodiments, and the calculation of the degree DDA of actual battery deterioration, which is performed in the battery management controller 43 of the server 2 in the above-described embodiments, may be performed in either the vehicle 1 or the server 2. That is, the functions of a process that can be performed in either the vehicle 1 or the server 2 may be divided as appropriate, and information may be exchanged in accordance with the division of roles.

In the present embodiment, the vehicle weight WV, mean outside air temperature TAAVE, total travel time TDRV, and serial number NPLOT are used as the deterioration-related parameters. The deterioration-related parameters are not limited to the above-described ones. Other parameters that have the effect on deterioration of the battery, for example, the temperature of the battery and the integrated value of the currents output by the battery, may also be used.

In the above-described embodiments, an example in which the present application is applied to a hybrid vehicle is illustrated. The present application is also applicable to an electric vehicle that has a motor driven by a battery as only one power source. In this case, in the charging-mode control illustrated in step S18 in FIG. 3 or 7, power-saving control of saving power used by the battery is mainly performed.

The value of the weight coefficient Pn applied to the above expressions (1) to (4) may preferably be updated in the server 2 if needed (for example, when a finding in the relationship between a deterioration-related parameter and battery deterioration is made), and the updated value may preferably be notified to the vehicle 1.

We claim:

1. A battery management system comprising:
a vehicle including a battery and a motor driven by power supplied from the battery as a power source; and
a server wirelessly connectable to the vehicle to communicate with each other,
the vehicle further including
a target battery remaining amount setting unit for setting by a user a destination and a target battery remaining amount when the vehicle reaches the destination,
a power consumption control unit that controls power consumption of the battery on the basis of the set target battery remaining amount such that the target battery remaining amount is realized, and
a parameter detecting or storing unit that detects or stores a deterioration-related parameter relating to deterioration of the battery,
the server including
a correlation storing unit that stores correlation between the deterioration-related parameter and a deterioration parameter coefficient representing a degree of an effect of the deterioration-related parameter on the deterioration of the battery,
the vehicle or the server including
an estimated battery deterioration degree calculating unit that calculates a degree of an estimated battery deterioration in accordance with the deterioration-related parameter and the correlation, and
an actual battery deterioration degree calculating unit that calculates a degree of an actual battery deterioration on the basis of an actual battery remaining amount at a point when the vehicle reaches the destination,
wherein the vehicle and the server exchange necessary information with each other,
the power consumption control unit controls the power consumption of the battery by referring to the degree of the estimated battery deterioration, and
the server modifies the correlation stored in the correlation storing unit in accordance with the degree of the actual battery deterioration.

2. The battery management system according to claim 1, wherein the deterioration-related parameter includes at least one of a serial number of the battery, an outside air temperature, a weight of the vehicle, and a total travel time of the vehicle.

3. The battery management system according to claim 1, wherein the vehicle or the server further includes
a determining unit that determines whether the target battery remaining amount set by using the target battery remaining amount setting unit is proper, and
a modified target battery remaining amount calculating unit that calculates a modified target battery remaining amount by modifying the set target battery remaining amount when the set target battery remaining amount is determined to be improper, and
the power consumption control unit controls the power consumption on the basis of the modified target battery remaining amount.

4. The battery management system according to claim 1, wherein the deterioration-related parameter includes a plurality of deterioration-related parameters,
the server further includes a weight coefficient storing unit that stores a weight coefficient associated with each of the deterioration-related parameters,
the estimated battery deterioration degree calculating unit uses the weight coefficient in the calculation of the degree of estimated battery deterioration, and
the server uses the weight coefficient in the modification of the correlation.

5. A battery management server wirelessly connectable to a vehicle to communicate with each other, the vehicle including a battery and a motor driven by power supplied from the battery as a power source, the battery management server comprising:
a correlation storing unit that stores correlation between a deterioration-related parameter relating to deterioration of the battery and a deterioration parameter coefficient representing a degree of an effect of the deterioration-related parameter on the deterioration of the battery;
a receiving unit that receives the deterioration-related parameter detected or stored in the vehicle and an actual battery remaining amount at a point when the vehicle reaches a destination; and
an actual battery deterioration degree calculating unit that calculates a degree of actual battery deterioration using the received deterioration-related parameter and the actual battery remaining amount received by the receiving unit,
wherein server modifies the correlation stored in the correlation storing unit in accordance with the degree of actual battery deterioration.

6. The battery management server according to claim 5, wherein the deterioration-related parameter includes a plurality of deterioration-related parameters,
the battery management server further comprises a weight coefficient storing unit that stores a weight coefficient associated with each of the deterioration-related parameters, and
the server modifies the correlation using the weight coefficient.

7. A battery management device for a vehicle including a battery and a motor driven by power supplied from the battery as a power source, the device comprising:
a target battery remaining amount setting unit for setting by a user a destination and a target battery remaining amount when the vehicle reaches the destination;
a power consumption control unit that controls power consumption of the battery on the basis of the set target battery remaining amount such that the target battery remaining amount is realized;
a parameter detecting or storing unit that detects or stores a deterioration-related parameter relating to deterioration of the battery;
a correlation storing unit that stores correlation between the deterioration-related parameter and a deterioration parameter coefficient representing a degree of an effect of the deterioration-related parameter on the deterioration of the battery;
an estimated battery deterioration degree calculating unit that calculates a degree of an estimated battery deterioration in accordance with the deterioration-related parameter and the correlation; and
an actual battery deterioration degree calculating unit that calculates a degree of an actual battery deterioration on the basis of an actual battery remaining amount at a point when the vehicle reaches the destination,
wherein the power consumption control unit controls the power consumption of the battery by referring to the degree of the estimated battery, and
the device modifies the correlation stored in the correlation storing unit in accordance with the degree of the actual battery deterioration.

8. The battery management device according to claim 7, wherein the deterioration-related parameter includes at least one of a serial number of the battery, an outside air temperature, a weight of the vehicle, and a total travel time of the vehicle.

9. The battery management device according to claim 7, further comprising:
a determining unit that determines whether the target battery remaining amount set by using the target battery remaining amount setting unit is proper; and
a modified target battery remaining amount calculating unit that calculates a modified target battery remaining amount by modifying the set target battery remaining amount when the set target battery remaining amount is determined to be improper,
wherein the power consumption control unit controls the power consumption on the basis of the modified target battery remaining amount.

10. A battery management method for a vehicle including a battery and a motor driven by power supplied from the battery as a power source, the method comprising:
setting by a user a destination and a target battery remaining amount when the vehicle reaches the destination;
detecting or storing a deterioration-related parameter relating to deterioration of the battery,
calculating a degree of an estimated battery deterioration in accordance with the deterioration-related parameter and a correlation between the deterioration-related parameter and a deterioration parameter coefficient representing a degree of an effect of the deterioration-related parameter on the deterioration of the battery,
controlling the power consumption of the battery on the basis of the set target battery remaining amount by referring to the degree of the estimated battery deterioration such that the target battery remaining amount is realized, and
calculating a degree of an actual battery deterioration on the basis of an actual battery remaining amount at a point when the vehicle reaches the destination,
modifying the correlation in accordance with the degree of the actual battery deterioration.

11. The battery management method according to claim 10, wherein the deterioration-related parameter includes at least one of a serial number of the battery, an outside air temperature, a weight of the vehicle, and a total travel time of the vehicle.

12. The battery management method according to claim 10, further comprising:
after the setting step, determining whether the target battery remaining amount set by the user is proper; and
calculating a modified target battery remaining amount by modifying the set target battery remaining amount when the set target battery remaining amount is determined to be improper,
wherein the controlling step controls the power consumption on the basis of the modified target battery remaining amount.

13. A battery management system comprising:
a vehicle including a battery and a motor driven by power supplied from the battery as a power source; and
a server wirelessly connectable to the vehicle to communicate with each other,
the vehicle further including
a target battery remaining amount setting means for setting by a user a destination and a target battery remaining amount when the vehicle reaches the destination,
a power consumption control means for controlling power consumption of the battery on the basis of the set target battery remaining amount such that the target battery remaining amount is realized, and
a parameter detecting or storing means for detecting or storing a deterioration-related parameter relating to deterioration of the battery,
the server including
a correlation storing means for storing correlation between the deterioration-related parameter and a deterioration parameter coefficient representing a degree of an effect of the deterioration-related parameter on the deterioration of the battery,
the vehicle or the server including
an estimated battery deterioration degree calculating means for calculating a degree of an estimated battery deterioration in accordance with the deterioration-related parameter and the correlation, and
an actual battery deterioration degree calculating means for calculating a degree of an actual battery deterioration on the basis of an actual battery remaining amount at a point when the vehicle reaches the destination,
wherein the vehicle and the server exchange necessary information with each other,
the power consumption control means controls the power consumption of the battery by referring to the degree of the estimated battery deterioration, and
the server modifies the correlation stored in the correlation storing means in accordance with the degree of the actual battery deterioration.

14. The battery management system according to claim 13, wherein the deterioration-related parameter includes at least one of a serial number of the battery, an outside air temperature, a weight of the vehicle, and a total travel time of the vehicle.

15. The battery management system according to claim 13, wherein the vehicle or the server further includes
a determining means for determining whether the target battery remaining amount set by using the target battery remaining amount setting means is proper, and
a modified target battery remaining amount calculating means for calculating a modified target battery remaining amount by modifying the set target battery remaining amount when the set target battery remaining amount is determined to be improper, and
the power consumption control means controls the power consumption on the basis of the modified target battery remaining amount.
